(19) United States
(12) Patent Application Publication
(10) Pub. No.: US 2026/0371335 A1
(43) Pub. Date: Nov. 19, 2026

(54) BEAM DETERMINATION IN DEPLOYMENTS WITH NETWORK CONTROLLED REPEATERS

(71) Applicant: Nokia Technologies Oy, Espoo (FI)

(72) Inventors: Andrea BONFANTE, Massy (FR); Rustam PIRMAGOMEDOV, Oulu (FI)

(21) Appl. No.: 19/153,768

(22) PCT Filed: Jan. 19, 2024
(86) PCT No.: PCT/EP2024/051206

§ 371 Date: Aug. 5, 2025

(30) Foreign Application Priority Data
Feb. 16, 2023 (FI) 20235181

(51) Int. Cl. H04W 72/044; H04W 16/26; H04W 72/542

(52) U.S. Cl. CPC H04W 72/046; H04W 16/26; H04W 72/542

(57) ABSTRACT

According to an aspect, there is provided a terminal apparatus that may be configured to receive, from a network apparatus, a message comprising an indication of downlink reference signal resources associated with the beams allocated to a network controlled repeater. The terminal apparatus may be configured to determine the best beam among beams provided by the network apparatus and beams provided by the network controlled repeater based on a decision between the beams indicated in the message and beams predicted by a machine learning model.

### TECHNICAL FIELD

Various example embodiments generally relate to the field of telecommunication systems. In particular, some example embodiments relate to a solution for determining the best beam in deployments with network controlled repeaters.

### BACKGROUND

In wireless communication networks, for example, a new radio (NR), a network controlled repeater (NCR) can be used to extend a coverage of a base station, for example, a gNodeB (gNB). The NCR is in-band radio frequency (RF) repeater that relays signals transmitted from the gNB to improve the network coverage. The NCR can thus be regarded as an extension of the gNB and has beamforming capability to provide access beams towards directions out-of-coverage in the gNB area.

As the NCR appears transparent to a user equipment (UE), the UE may not know whether it is connected to a parent qNB via the NCR or with a direct link to the gNB. Therefore, the UE may use a machine learning (ML) model for predicting the best Tx beam or best beam pair (Tx/Rx beam) trained with only the gNB beams and without any NCR access beams. This means that the ML model used for a beam prediction may fail to predict the best beam identifier and/or a reference signal received power (RSRP) when the UE is served by the NCR. In addition to this, the UE may not know the reason for the ML model failure.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution for determining the best beam when a wireless communication network comprises a network repeater, for example, a network controlled repeater. This benefit may be achieved by the features of the independent claims. Further implementation forms are provided in the dependent claims, the description, and the drawings.

According to a first aspect, a terminal apparatus may comprise at least one processor and at least one memory storing instructions, that when executed by the at least one processor, cause the terminal apparatus to perform: receiving, from a network apparatus, a message comprising an indication of downlink reference signal resources associated with the beams allocated to a network controlled repeater; and determining the best beam among beams transmitted by the network apparatus and beams transmitted by the network controlled repeater based on a decision between the beams indicated in the message and beams predicted by a machine learning model.

In an example embodiment of the first aspect, the instructions, when executed by the at least one processor, cause the terminal apparatus to perform: running the machine learning model for the beams transmitted by the network apparatus to predict the best beam among the beams transmitted by the network apparatus; measuring a reference signal received power of each beam allocated to the network controlled repeater; and determining the best beam among the beams transmitted by the network apparatus and the beams transmitted by the network controlled repeater based on the reference signal received power of the predicted best beam of the beams transmitted by the network apparatus and the measured reference signal received power of the beams allocated to the network controlled repeater.

In an example embodiment of the first aspect, the instructions, when executed by the at least one processor, cause the terminal apparatus to perform: obtaining a network controlled repeater compatible machine learning model, the network controlled repeater compatible machine learning model being capable of predicting the best beam transmitted by the network controlled repeater; and running the network controlled repeater compatible machine learning model for the beams transmitted by the network apparatus and the beams transmitted by the network controlled repeater to predict the best beam among the beams transmitted by the network apparatus and the beams transmitted by the network controlled repeater.

In an example embodiment of the first aspect, the instructions, when executed by the at least one processor, cause the terminal apparatus to perform: collecting measurement data relating to the beams transmitted by the network controlled repeater, the measurement data comprising a measured reference signal received power of each beam transmitted by the network controlled repeater; and training the network controlled repeater compatible machine learning model based on the collected measurement data and the machine learning model.

In an example embodiment of the first aspect, the instructions, when executed by the at least one processor, cause the terminal apparatus to perform: applying transfer learning in training the network controlled repeater compatible machine learning model based on the collected measurement data and parameters of the machine learning model trained for the beams transmitted by the network apparatus.

In an example embodiment of the first aspect, the instructions, when executed by the at least one processor, cause the terminal apparatus to perform: training the network controlled repeater compatible machine learning model by initializing parameters randomly.

In an example embodiment of the first aspect, the instructions, when executed by the at least one processor, cause the terminal apparatus to perform: transmitting the network controlled repeater compatible machine learning model to the network apparatus.

In an example embodiment of the first aspect, the instructions, when executed by the at least one processor, cause the terminal apparatus to perform: receiving the network controlled repeater compatible machine learning model from the network apparatus.

In an example embodiment of the first aspect, the instructions, when executed by the at least one processor, cause the terminal apparatus to perform: transmitting to the network apparatus information relating to capabilities of the machine learning model for beam prediction.

In an example embodiment of the first aspect, the instructions, where the beams comprise synchronization signal block beams or channel state information reference signal beams.

According to a second aspect, a network apparatus may comprise at least one processor and at least one memory storing instructions, that when executed by the at least one processor, cause the network apparatus to perform: transmitting, to a terminal apparatus, a message comprising an indication of downlink reference signal resources associated with the beams allocated to a network controlled repeater.

In an example embodiment of the second aspect, the instructions, when executed by the at least one processor, cause the network apparatus to perform: receiving, from the terminal apparatus, a network controlled repeater compatible machine learning model, the network controlled repeater compatible machine learning model being capable of predicting the best beam transmitted by the network controlled repeater.

In an example embodiment of the second aspect, the instructions, when executed by the at least one processor, cause the network apparatus to perform: transmitting the network controlled repeater compatible machine learning model to a second terminal apparatus served by the network controlled repeater.

In an example embodiment of the second aspect, the instructions, where the beams comprise synchronization signal block beams or channel state information reference signal beams.

According to a third aspect, a method comprises receiving, by a terminal apparatus from a network apparatus, a message comprising an indication of downlink reference signal resources associated with the beams allocated to a network controlled repeater; and determining, by the terminal apparatus, the best beam among beams transmitted by the network apparatus and beams transmitted by the network controlled repeater based on a decision between the beams indicated in the message and beams predicted by a machine learning model.

In an example embodiment of the third aspect, the method further comprises running the machine learning model for the beams transmitted by the network apparatus to predict the best beam among the beams transmitted by the network apparatus; measuring a reference signal received power of each beam allocated to the network controlled repeater; and determining the best beam among the beams transmitted by the network apparatus and the beams transmitted by the network controlled repeater based on the reference signal received power of the predicted best beam of the beams transmitted by the network apparatus and the measured reference signal received power of the beams allocated to the network controlled repeater.

In an example embodiment of the third aspect, the method further comprises obtaining a network controlled repeater compatible machine learning model, the network controlled repeater compatible machine learning model being capable of predicting the best beam transmitted by the network controlled repeater; and running the network controlled repeater compatible machine learning model for the beams transmitted by the network apparatus and the beams transmitted by the network controlled repeater to predict the best beam among the beams transmitted by the network apparatus and the beams transmitted by the network controlled repeater.

In an example embodiment of the third aspect, the method further comprises collecting measurement data relating to the beams transmitted by the network controlled repeater, the measurement data comprising a measured reference signal received power of each beam transmitted by the network controlled repeater; and training the network controlled repeater compatible machine learning model based on the collected measurement data and the machine learning model.

In an example embodiment of the third aspect, the method further comprises applying transfer learning in training the network controlled repeater compatible machine learning model based on the collected measurement data and parameters of the machine learning model trained for the beams transmitted by the network apparatus.

In an example embodiment of the third aspect, the method further comprises training the network controlled repeater compatible machine learning model by initializing parameters randomly.

In an example embodiment of the third aspect, the method further comprises transmitting the network controlled repeater compatible machine learning model to the network apparatus.

In an example embodiment of the third aspect, the method further comprises receiving the network controlled repeater compatible machine learning model from the network apparatus.

In an example embodiment of the third aspect, the method further comprises transmitting to the network apparatus information relating to capabilities of the machine learning model for beam prediction.

In an example embodiment of the third aspect, the instructions, where the beams comprise synchronization signal block beams or channel state information reference signal beams.

According to a fourth aspect, a method comprises transmitting, by a network apparatus to a terminal apparatus, a message comprising an indication of downlink reference signal resources associated with the beams allocated to a network controlled repeater.

In an example embodiment of the fourth aspect, the method further comprises receiving, from the terminal apparatus, a network controlled repeater compatible machine learning model, the network controlled repeater compatible machine learning model being capable of predicting the best beam transmitted by the network controlled repeater.

In an example embodiment of the fourth aspect, the method further comprises transmitting the network controlled repeater compatible machine learning model to a second terminal apparatus served by the network controlled repeater.

According to a fifth aspect a computer program comprises instructions for causing an apparatus to carry out the method of the third aspect.

According to a sixth aspect a computer program comprises instructions for causing an apparatus to carry out the method of the fourth aspect.

According to a seventh aspect a computer readable medium comprises a computer program comprising instructions for causing an apparatus to carry out the method of the third aspect.

According to an eighth aspect a computer readable medium comprises a computer program comprising instructions for causing an apparatus to carry out the method of the fourth aspect.

According to a ninth aspect, an apparatus may comprise means for: receiving, by a terminal apparatus from a network apparatus, a message comprising an indication of downlink reference signal resources associated with the beams allocated to a network controlled repeater; and determining, by the terminal apparatus, the best beam among beams transmitted by the network apparatus and beams transmitted by the network controlled repeater based on a decision between the beams indicated in the message and beams predicted by a machine learning model.

According to a tenth aspect, an apparatus may comprise means for: transmitting, by a network apparatus to a terminal apparatus, a message comprising an indication of downlink reference signal resources associated with the beams allocated to a network controlled repeater.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates a system according to an example

FIG. 2A illustrates an example of a method according to an example embodiment.

FIG. 2B illustrates an example of a method according to an example embodiment.

FIG. 3 illustrates a wireless communication system according to an example embodiment.

FIG. 4 illustrates a flow diagram according to an example embodiment.

FIG. 5 illustrates a wireless communication system according to an example embodiment.

FIG. 6 illustrates a flow diagram according to an example embodiment.

FIG. 7 illustrates a wireless communication system according to an example embodiment.

FIG. 8 illustrates an example for updating an ML model using transfer learning according to an example embodiment.

FIG. 9 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

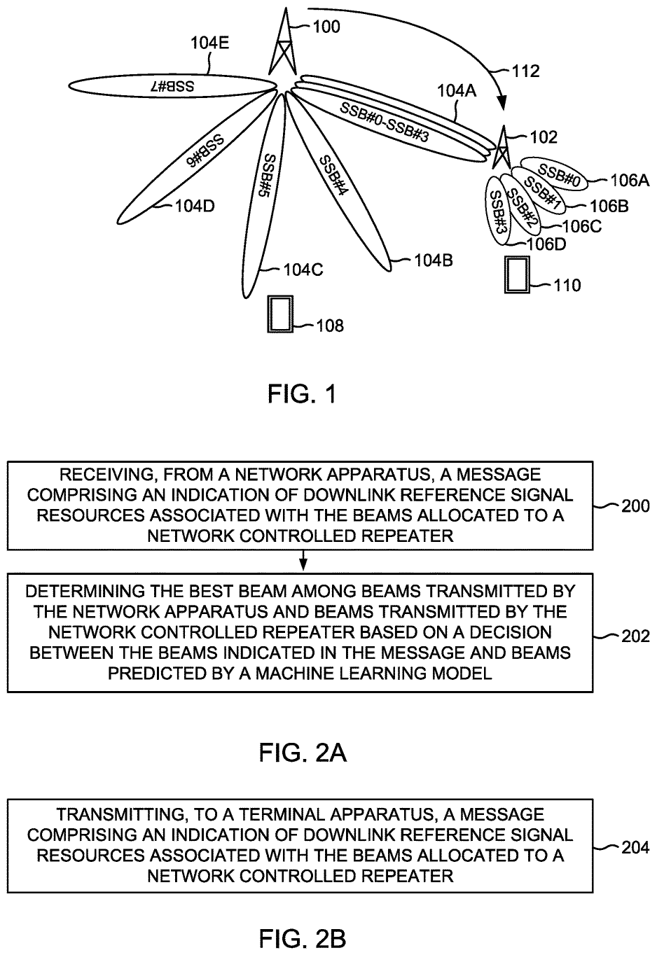

FIG. 1 illustrates a wireless communication system according to an example embodiment. The wireless communication system comprises a base station 100, for example, a gNB, and a network repeater, for example, a network controlled repeater (NCR) 102. The NCR 102 is in-band radio frequency (RF) repeater that relays signals transmitted from the gNB 100 to improve the network coverage. The NCR 102 appears transparent to a user equipment (UE) 110.

The gNB 100 provides a backhaul to the NCR 102, which functions as an extension of the gNB 100 and has beamforming capability to provide access beams 106A-106D towards directions out-of-coverage in the gNB 100 area. This means that in addition to manage its own Tx/Rx beams, the gNB 100 will also manage the access beams 106A-106D of the NCR 102. The NCR 102 may forward a set of additional SSBs specifically allocated to the NCR 102. The gNB 100 may also exchange side control link information 112 with the NCR 102 to control the access beams 106A-106D.

As the NCR 102 appears transparent to the UE 110, the UE 110 may not know whether it is connected to a parent gNB 100 via the NCR 102 or with a direct link to the gNB 100. Therefore, the UE 110 may use a machine learning (ML) model for predicting the best Tx beam or best beam pair (Tx/Rx beam) trained with only the gNB beams and without any NCR access beams. This means that the ML model used for a beam prediction may fail to predict the best beam identifier and/or a reference signal received power (RSRP) when the UE is served by the NCR. In addition to this, the UE may not know the reason for the ML model failure.

Since the NCR 102 appears transparent to the UE 110, the UE 110 may not know whether it is connected to the parent gNB 100 via the NCR 102 or with a direct link to the gNB 100. Therefore, the UE 110 may use an ML model for predicting the best Tx beam or best beam pair (Tx/Rx beam) trained with only the gNB beams 104A-104E and without any access beams 106A-106D. This may mean that ML model used for the beam prediction may fail to predict the best beam identifier and/or RSRP when the UE 110 is served by the NCR 102. Further, the UE 110 may not know the reason for the ML model failures.

In the following, to address the above drawbacks, the current framework for the beam prediction is extended to generalize the ML model operations to network architectures that include NCRs.

FIG. 2A illustrates an example of a method according to an example embodiment. The method may be implemented by a terminal apparatus, for example, user equipment wirelessly connected to a network apparatus, for example, a base station or a gNB.

At 200, a message comprising an indication of downlink reference signal resources associated with the beams allocated to an NCR may be received from a network apparatus. The beams may comprise, for example, synchronization signal block (SSB) beams or channel state information reference signal (CSI-RS) beams. A synchronization signal block identifier may be associated with a respective beam transmitted by the NCR. The gNB may provide a backhaul to the NCR, which functions as an extension of the gNB and has beamforming capability to provide access beams towards directions out-of-coverage in the gNB area.

At 202, the best beam among beams transmitted by the network apparatus and beams transmitted by the NCR may be determined based on a decision between the beams indicated in the message and beams predicted by an ML model.

In an example embodiment, the UE may be configured to run the ML model for the beams transmitted by the gNB to predict the best beam among the beams transmitted by the network apparatus. As the ML model has been trained in a conventional network without NCRs, the ML model provides an acceptable result only for the beams transmitted by the gNB. With respect to the beams transmitted by the NCR, the UE may be configured to measure a RSRP of each beam allocated to the NCR. The terminal device may then be configured to determine the best beam among the beams transmitted by the network apparatus and the beams transmitted by the network NCR based on the reference signal received power of the predicted best beam of the beams transmitted by the network apparatus and the measured reference signal received power of the beams allocated to the NCR. This solution provides a hybrid beam reporting implementation in which the best beam is decided between predicted and measured beams. In an example embodiment, the UE may compare the RSRP of the best beam transmitted by the gNB and predicted by the ML model with the RSRP measured on the beams transmitted by the NCR. If the RSRP of the best-predicted beam by the ML model is higher than the RSRP measured with the beams transmitted by the NCR, the UE may report the beam identifier and/or RSRP of the best beam predicted by the ML model. This is the likely situation that would happen with an UE being close to a beam transmitted by the gNB. If the RSRP of the beams transmitted by the NCR is higher than the RSRP of the best-predicted beam by the ML model, the UE may report the beam identifier and/or RSRP of the best beam transmitted by the NCR. This is the likely situation that would happen with an UE being close to a beam transmitted by the NCR.

In an example embodiment, the UE may be configured to obtain an NCR compatible ML model, the NCR compatible ML model being capable of predicting the best beam, for example, the identifier and/or RSRP corresponding to the best beam, transmitted by the NCR; and run the NCR compatible ML model for the beams transmitted by the network apparatus and the beams transmitted by the NCR to predict the best beam among the beams transmitted by the network apparatus and the beams transmitted by the NCR. For example, the NCR compatible ML model may be run by inputting measurements corresponding to a subset of the beams transmitted by the network apparatus and a subset of the beams transmitted by the NCR. This may provide a solution in which the NCR compatible ML model has been trained elsewhere and the UE may use the ready ML model.

In an example embodiment, the UE may be configured to collect measurement data relating to the beams transmitted by the NCR, the measurement data comprising a measured reference signal received power of each beam transmitted by the NCR. Based on the collected measurement data and the ML model, the UE may be configured to train the NCR compatible ML model. For example, the UE may be configured to train the NCR compatible ML model using the collected measurements data as an input of the ML model and the corresponding identifier of the best beam from the NCR as an output of the ML model. As the ML model has been updated (i.e. trained) to take into account the beams transmitted by the NCR, there is no need to perform any additional RSRP measurements in order to determine the best beam. Instead, the best beam may be determined based on prediction only as the NCR compatible ML model takes into account also the beams transmitted by the NCR. In an example embodiment, the NCR compatible ML model may be a supervised and NCR compatible ML model. In an example embodiment, the training may alternatively be performed with semi-supervised and unsupervised learning.

In an example embodiment, the UE may be configured to apply transfer learning in training the NCR compatible ML model based on the collected measurement data and parameters of the ML model trained for the beams transmitted by the network apparatus. The transfer learning solution may use the original ML model, which has already been trained before, and the original ML model can then be updated for the new task of predicting the best beam in a network with the NCR. In another example embodiment, the NCR ML model may be trained by initializing parameters randomly.

In an example embodiment, the UE may be configured to transmit the NCR compatible ML model to the gNB. The gNB may store the ML model for later use by other UEs. The UE may also attach metadata to the header of the file containing the model. Using the metadata, gNB may identify other UEs (for example, with the same vendor identifier) that may need to use the ML model. In an example embodiment, the UE may also encrypt the ML model's file to preserve proprietary design and in that case, the gNB can only read metadata, but the ML model itself is not accessible by gNB.

In an example embodiment, the UE may be configured to receive the NCR compatible ML model from the gNB. The gNB may have received the NCR compatible ML model from another UE, and the NCR compatible ML model may then be provided to the UE. As the ML model has been updated (i.e. trained) to take into account the beams transmitted by the NCR, there is no need to perform any additional RSRP measurements in order to determine the best beam. Instead, the best beam may be determined based on prediction only as the NCR compatible ML model takes into account also the beams transmitted by the NCR.

In an example embodiment, the UE may be configured to transmit to the gNB information relating to capabilities of the ML model for beam prediction. The indication of the capabilities relating to the ML model, for example, the preferred number of the beams to be measured and the number of beams to be predicted, may help to reach a common understanding between the gNB and the UE. The ML model may not be compatible with the NCR, but it may still at least support the number of Tx beams transmitted by the gNB.

FIG. 2B illustrates an example of a method according to an example embodiment. The method may be implemented by a network apparatus, for example, a base station or a gNB, serving a terminal apparatus, for example, a UE.

At 204, the gNB may be configured to transmit to the UE a message comprising, for example, an indication of downlink reference signal resources associated with the beams allocated to an NCR. The beams may comprise, for example, comprise synchronization signal block (SSB) beams or channel state information reference signal (CSI-RS) beams. Each synchronization signal block identifier may be associated with a respective beam transmitted by the NCR. When providing the indication of the beams to the UE, the gNB enables the UE to correctly take into account beams transmitted by the NCR, when the UE determines the best beam among the beams transmitted by the gNB and the NCR.

In an example embodiment, the gNB may be configured to receive, from the UE, an NCR compatible ML model, the NCR compatible ML model being capable of predicting the best beam transmitted by the NCR. For example, the NCR compatible ML model may be capable of predicting the identifier and/or RSRP corresponding to the best beam. The gNB may then be configured to transmit the NCR compatible ML model to a second terminal apparatus served by NCR. This may enable a solution in which the gNB transmits to the UE an already updated ML model that has been updated (i.e. trained) to take into account the beams transmitted by the NCR, and there is no need to perform any additional RSRP measurements with the UE in order to determine the best beam. Instead, the best beam may be determined based on prediction only as the NCR compatible ML model takes into account also the beams transmitted by the NCR.

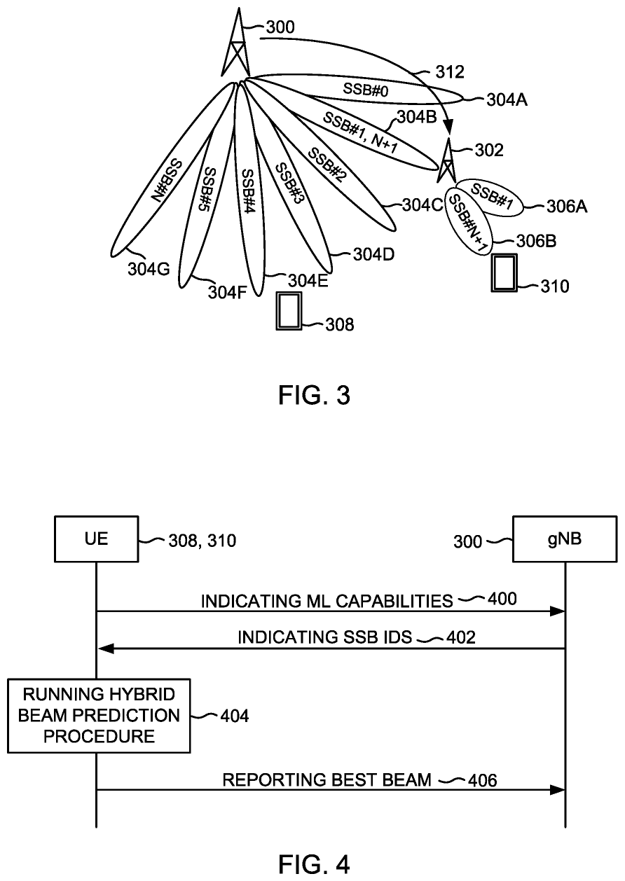

FIG. 3 illustrates a wireless communication system according to an example embodiment. The wireless communication system comprises a network node 300, for example, a base station or a gNB, and an NCR 302. The NCR 302 is in-band radio frequency (RF) repeater that relays signals transmitted from the gNB 300 to improve the network coverage. The NCR 302 appears transparent to a user equipment (UE) 108, 110.

The gNB 300 provides a backhaul to the NCR 302, which functions as an extension of the gNB 300 and has beamforming capability to provide access beams 306A-306B towards directions out-of-coverage in the gNB 300 area. This means that in addition to manage its own Tx/Rx beams 304A-304G, the gNB 300 will also manage the access beams 306A-306B of the NCR 302. The NCR 302 may forward a set of additional SSBS specifically allocated to the NCR 302. The gNB 300 may also exchange side control link information 312 with the NCR 302 to control the access beams 306A-306B. In the example illustrated in FIG. 3, the gNB provides beams 304A-304G and the NCR 302 provides beams 306A-306B. FIG. 3 also illustrated two terminal devices 308, 310, for example, UES. Instead of using SSBs, CSI-RSs may be used. The SSB/CSI-RS is transmitted from the gNB 300 and/or the NCR 302 towards the UE 310 with determined beam directions.

FIG. 4 illustrates a flow diagram according to an example embodiment. In the following, FIG. 4 is discussed together with FIG. 3. The example illustrated in FIG. 4 assumes that the gNB beams 304B are used for backhauling the NCR 302, which in turn serves the UE 310 with access beams 306A-306B which have shape/direction/power different from the gNB beams 304A-304G. It is also assumed that the ML model used has been trained in a conventional network without the NCR 302. It is also assumed that the NCR 302 is operated by the gNB 300 with side control link information 312 exchanged between the gNB 300 and the NCR 302 to control the NCR access beams 306A-306B.

At 400, the UE 308, 310 may be configured to transmit to the gNB 300 a message that comprises an indication of capabilities relating to an ML model applied by the UE 308, 310 for the best beam prediction. This may include the number of beams to be measured and the number of beams to be predicted. The indication of the capabilities relating to the ML model, for example, the preferred number of the beams to be measured and the number of beams to be predicted, may help to reach a common understanding between gNB 300 and the UE 308, 310. The ML model may not be compatible with the NCR 302, but it may still at least support the number of Tx beams transmitted by the gNB 300. At 402, the UE 308, 310 is configured to receive from the gNB 300 a message comprising an indication of downlink reference signal resources associated with the beams allocated to the NCR 302, for example, SSB identifiers allocated to the NCR 302, each SSB identifier being associated with a respective beam transmitted by the NCR 302. In another example embodiment, instead of using SSBs, channel state information reference signals (CSI-RS) may be used. This enables the UE 308, 310 to measure all the NCR access beams 306A-306B one beam at a time to establish the best beam having a higher RSRP.

At 404, in response to receiving the message at 402, the UE 308, 310 is configured to run the ML model for predicting the best beam RSRP for beams from the gNB 300 (thus not including the beams 306A-306B from the NCR 302). The RSRPs of the beams 306A-306B allocated to the NCR 302 are measured utilizing a conventional procedure. In other words, the gNB 302 may configure the UE 308, 310 to perform additional measurements for the NCR access beams 306A-306B while changing the NCR access beam direction through the control link. The UE 308, 310 may save in memory a vector of measurements of the NCR access beams 306A-306B and the corresponding beam identifiers (extracted by decoding the SSB).

At 406, the UE 308, 310 may be configured to report the best beam to the gNB 300. The UE 308, 310 reports the best beam's RSRP predicted by the ML model if it is higher than the best beam's RSRP measured from the NCR 302. Otherwise, the UE 308, 310 reports the best beam from the NCR 302. If the RSRP of the best-predicted beam by ML model is higher than the RSRP measured with the NCR access beams 306A-306B, the UE reports the beam identifier and/or RSRP of the best beam predicted by the ML model. This is the likely situation that would happen with the UE 308. If the RSRP of the NCR access beams 306A-306B is higher than the RSRP of the best-predicted gNB beam 304A-304G by the ML model, the UE reports the beam identifier and/or RSRP of the best beam measured with NCR access beams 306A-306B. This is the likely situation that would happen with the UE 310.

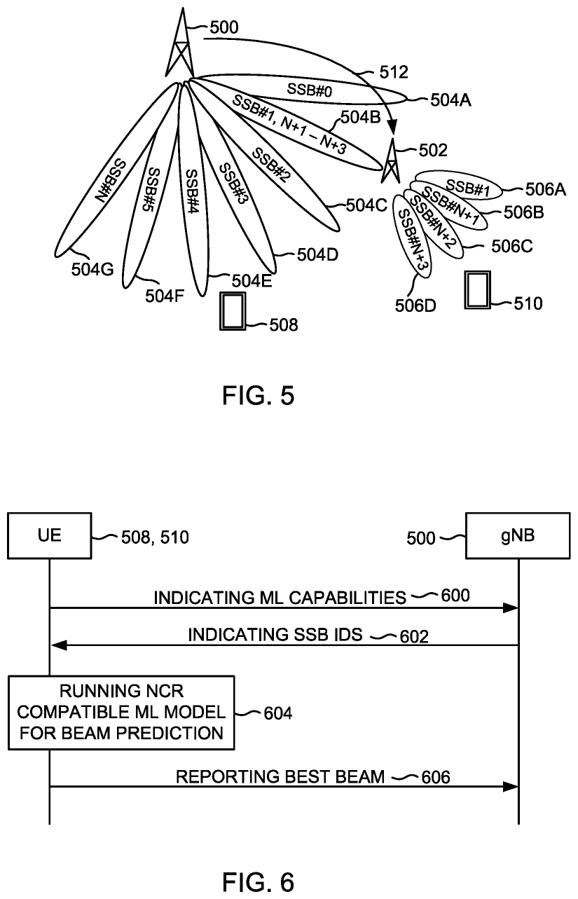

FIG. 5 illustrates a wireless communication system according to an example embodiment. The wireless communication system comprises a network node 500, for example, a base station or a gNB, and an NCR 502. The NCR 502 is in-band radio frequency (RF) repeater that relays signals transmitted from the gNB 500 to improve the network coverage. The NCR 502 appears transparent to a user equipment (UE) 508, 510.

The gNB 500 provides a backhaul to the NCR 502, which functions as an extension of the gNB 500 and has beamforming capability to provide access beams 506A-506D towards directions out-of-coverage in the gNB 500 area. This means that in addition to manage its own Tx/Rx beams 504A-504G, the gNB 500 will also manage the access beams 506A-506D of the NCR 502. The NCR 502 may forward a set of additional SSBs specifically allocated to the NCR 502. The gNB 500 may also exchange side control link information 512 with the NCR 502 to control the access beams 506A-506D. In the example illustrated in FIG. 5, the gNB provides beams the 504A-504G and the NCR 502 provides the beams 506A-506D. FIG. 5 also illustrates two terminal devices 508, 510, for example, UEs.

FIG. 6 illustrates a flow diagram according to an example embodiment. In the following, FIG. 6 is discussed together with FIG. 5. The example illustrated in FIG. 6 assumes that the gNB beams 504B are used for backhauling the NCR 502, which in turn serves the UE 510 with access beams 506A-506D which have shape/direction/power different from the gNB beams 504A-504G. It is also assumed that the ML model used has been trained in a conventional network without the NCR 502. It is also assumed that the NCR 502 is operated by the gNB 500 with side control link information 512 exchanged between the gNB 500 and the NCR 502 to control the NCR access beams 506A-506D.

At 600, the UE 508, 510 is configured to transmit to the gNB 500 a message that comprises an indication of capabilities relating to a ML model applied by the UE 508, 510 for the best beam prediction. The indication of the capabilities relating to the ML model, for example, the preferred number of the beams to be measured and the number of beams to be predicted, may help to reach a common understanding between gNB 500 and the UE 508, 510. The ML model may not be compatible with the NCR 502, but it may still at least support the number of Tx beams transmitted by the gNB 500. At 602, the UE 508, 510 is configured to receive from the gNB 500 a message comprising an indication of downlink reference signal resources associated with the beams allocated to the NCR 502, for example, SSB identifiers allocated to the NCR 502, each SSB identifier being associated with a respective beam transmitted by the NCR 502. In another example embodiment, instead of using SSBs, channel state information reference signals (CSI-RS) may be used.

At 604, in response to receiving the message at 602, the UE 508, 510 is configured to run a NCR compatible ML model for predicting the best beam RSRP for the beams from the gNB 500 and the NCR 502. In an example embodiment, the gNB 500 may be configured to transmit the NCR compatible ML model to the UE 508, 510. In another example embodiment, the UE 508, 510 may have trained the NCR compatible ML model based on a previously configured ML model that did not take into account the NCR 502 and the beams 506A-506D transmitted by the NCR 502.

At 606, the UE 508, 510 may be configured to report the best beam to the gNB 500. With respect to the UE 508, the UE 508 may predict accurately the best gNB beam (i.e., beam ID 4 in the example illustrated in FIG. 5) since NCR compatible ML model has been trained to take into account the NCR 502 and the beams 506A-506D transmitted by the NCR 502. With respect to the UE 510, the UE 510 may predict accurately the best NCR access beam (i.e., beam ID N+2 in the example illustrated in FIG. 5) since NCR compatible ML model has been trained to take into account the NCR 502 and the beams 506A-506D transmitted by the NCR 502.

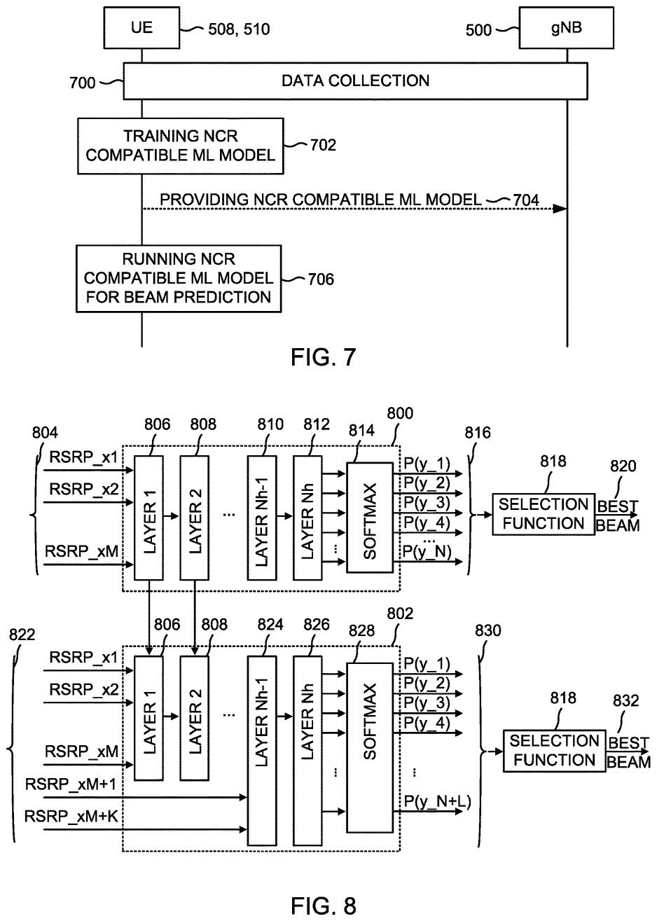

FIG. 7 illustrates a flow diagram according to an example embodiment. FIG. 7 illustrates a solution for obtaining a NCR compatible ML model.

At 700, the UE 508, 510 may be configured to collect data relating to the NCR access beams 506A-506D. The data may include, for example, measurements of the NCR access beams 506A-506D paired with the beams' identifiers.

At 702 the UE 508, 510 may be configured to train an NCR compatible ML model based on an existing ML model that does not yet take into account the NCR 502 and its beams 506A-506D, using the data collected at 700. In an example embodiment, a transfer learning solution can be used to avoid retraining the entire ML model from the start. The transfer learning solution is discussed in more detail in FIG. 8 and its description. In another example embodiment, the NCR compatible ML model may be trained by initializing parameters randomly.

At 704, the UE 508, 510 may be optionally configured to transmit the NCR compatible ML model to the gNB 500, which can store the model for later use by other UEs. The UE 508, 510 may also attach metadata to the header of the file containing the NCR compatible ML model. Using the metadata, gNB 500 may identify other UEs (for example, with the same vendor identifier) that may need to use the same ML model. In an example embodiment, the UE 508, 510 may be configured to encrypt the ML model's file to preserve proprietary design. Thus, the gNB 500 can only read the metadata, but the ML model itself is not accessible to the gNB 500.

At 706, the UE 508, 510 may be configured to run the NCR compatible ML model for beam prediction, as discussed in more detail in FIG. 6 and its description.

FIG. 8 illustrates an example for updating a ML model 800 using transfer learning according to an example embodiment. The ML model 800 does not yet take into account the NCR and its beams.

The ML model 800 takes as an input 804 RSRP measurements corresponding to the beams of the gNB. After layers 806-812 and a softmax layer 814, an output 816 is provided. A selection function 818 then selects the best beam 820 based on the output 816.

Taking into account that the trained parameters of the ML model 800 include the knowledge of predicting the best Tx beam of the gNB, they can be applied to the closely related task of predicting the best beam in a network with the NCR.

When then implementing the transfer learning, in this example, the parameters relating to the first two layers 806, 808 of the ML model 800 are used, and the ML model 800 is updated by training the remaining layers, i.e. layers 824 and 826, using data collected with the measurements of the NCR access beams. Other examples for implementing transfer learning may transfer the parameters of any number of layers and/or freeze, retrain, fine-tune the parameters of the transferred layers to improve the prediction accuracy. The ML model 802 takes as an input 822 RSRP measurements corresponding to the beams of the gNB and the beams of the NCR. After layers 806, 808, 824 and 826 and a softmax layer 828, an output 830 is provided. A selection function 818 then selects the best beam 832 based on the output 830. The best beam may be a gNB beam or an NCR access beam.

The NCR compatible ML model 800, i.e. the ML model 802, is compatible with the NCR access beams and can be applied for the task of predicting the best beam in a network comprising also the NCR.

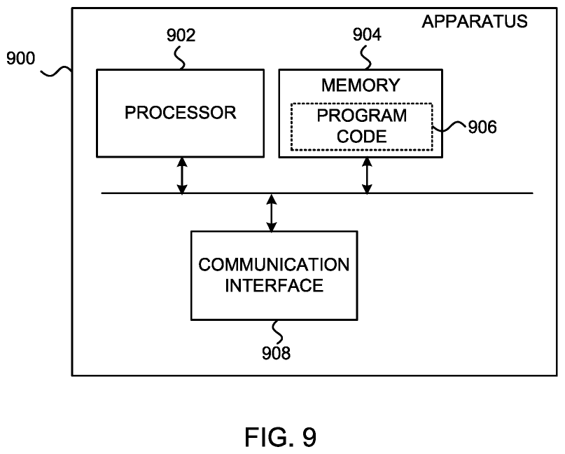

FIG. 9 illustrates an example of an apparatus 900 configured to practice one or more example embodiments. The apparatus 900 may comprise, for example, an access node, a base station, a gNB, a radio network node or a split portion thereof, a terminal apparatus, a user node, a user equipment, or in general a device configured to implement the functionality described herein. Although the apparatus 900 is illustrated as a single device, it is appreciated that, wherever applicable, functions of the apparatus 900 may be distributed to a plurality of devices.

The apparatus 900 may comprise at least one processor 902. The at least one processor 902 may comprise, for example, one or more of various processing devices or processor circuitry, such as, for example, a co-processor, a microprocessor, a controller, a Digital Signal Processor (DSP), a processing circuitry with or without an accompanying DSP, or various other processing devices including integrated circuits such as, for example, an Application Specific Integrated Circuit (ASIC), a Field Programmable Gate Array (FPGA), a Microcontroller Unit (MCU), a hardware accelerator, a special-purpose computer chip, or the like.

The apparatus 900 may further comprise at least one memory 904. The at least one memory 904 may be configured to store, for example, computer program code or the like, for example, operating system software and application software. The at least one memory 904 may comprise one or more volatile memory devices, one or more non-volatile memory devices, and/or a combination thereof. For example, the at least one memory 904 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 900 may further comprise a communication interface 908 configured to enable the apparatus 900 to transmit and/or receive information to/from other devices. In one example, the apparatus 900 may use the communication interface 908 to transmit or receive signaling information and data in accordance with at least one data communication or cellular communication protocol. The communication interface 908 may be configured to provide at least one wireless radio connection, such as, for example, a 3GPP mobile broadband connection (e. g. 3G, 4G, 5G, 6G etc.) . The communication interface 908 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 908 may comprise a receiver, a transmitter or a transceiver.

When the apparatus 900 is configured to implement some functionality, some component and/or components of the apparatus 900, for example, the at least one processor 902 and/or the at least one memory 904, may be configured to implement this functionality. Furthermore, when the at least one processor 902 is configured to implement some functionality, this functionality may be implemented using the program code 906 comprised, for example, in the at least one memory 904.

The functionality described herein may be performed, at least in part, by one or product components such as software components. According to an embodiment, the apparatus may comprise a processor or processor circuitry, for example, a microcontroller, configured by the program code when executed to execute the embodiments of the operations and functionality described herein. The program code 906 is provided as an example of instructions which, when executed by the at least one processor 902, cause performance of apparatus. Alternatively, or in addition, the functionality described herein can be performed, at least in part, by one or more hardware logic components. For example, and without limitation, illustrative types of hardware logic components that can be used include Field-programmable Gate Arrays (FPGAS), Application-Specific Integrated Circuits (ASICs), Application-Specific Standard Products (ASSPs), System-on-a-chip systems (SOCs), Complex Programmable Logic Devices (CPLDs), and Graphics Processing Units (GPUS).

The apparatus 900 may be configured to perform or cause performance of any aspect of the method(s) described herein, for example, the functions executed by the UE or the gNB. Further, a computer program may comprise instructions for causing, when executed, an apparatus to perform any aspect of the method(s) described herein. The computer program may be stored on a computer-readable medium. Further, the apparatus 900 may comprise means for performing any aspect of the method(s) described herein. In one example, the means may comprise the at least one processor 902, the at least one memory 904 including the program code 906 (instructions) configured to, when executed by the at least one processor 902, cause the apparatus 900 to perform the method(s). In general, computer program instructions may be executed on means providing generic processing functions. The method(s) may be thus computer-implemented, for example based algorithm(s) executable by the generic processing functions, an example of which is the at least one processor 902. The means may comprise transmission and/or reception means, for example one or more radio transmitters or receivers, which may be coupled or be configured to be coupled to one or more antennas, or transmitter(s) or receiver(s) of a wired communication interface.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s) ), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A terminal apparatus comprising:
at least one processor; and
at least one memory storing instructions, that when executed by the at least one processor, cause the terminal apparatus to perform:
receiving, from a network apparatus, a message comprising an indication of downlink reference signal resources associated with beams allocated to a network controlled repeater, wherein the network controlled repeater appears transparent to the terminal apparatus; and determining the best beam among beams transmitted by the network apparatus and beams transmitted by the network controlled repeater based on a decision between the beams indicated in the message and beams predicted by a machine learning model.

2. The terminal apparatus according to claim 1, wherein the instructions, when executed by the at least one processor, cause the terminal apparatus to perform:
running the machine learning model for the beams transmitted by the network apparatus to predict the best beam among the beams transmitted by the network apparatus;
measuring a reference signal received power of each beam allocated to the network controlled repeater; and
determining the best beam among the beams transmitted by the network apparatus and the beams transmitted by the network controlled repeater based on the reference signal received power of the predicted best beam of the beams transmitted by the network apparatus and the measured reference signal received power of the beams allocated to the network controlled repeater.

3. The terminal apparatus according to claim 1, wherein the instructions, when executed by the at least one processor, cause the terminal apparatus to perform:
obtaining a network controlled repeater compatible machine learning model, the network controlled repeater compatible machine learning model being capable of predicting the best beam transmitted by the network controlled repeater; and
running the network controlled repeater compatible machine learning model for the beams transmitted by the network apparatus and the beams transmitted by the network controlled repeater to predict the best beam among the beams transmitted by the network apparatus and the beams transmitted by the network controlled repeater.

4. The terminal apparatus according to claim 3, wherein the instructions, when executed by the at least one processor, cause the terminal apparatus to perform:
collecting measurement data relating to the beams transmitted by the network controlled repeater, the measurement data comprising a measured reference signal received power of each beam transmitted by the network controlled repeater; and
training the network controlled repeater compatible machine learning model based on the collected measurement data and the machine learning model.

5. The terminal apparatus according to claim 3, wherein the instructions, when executed by the at least one processor, cause the terminal apparatus to perform:
collecting measurement data relating to the beams transmitted by the network controlled repeater, the measurement data comprising a measured reference signal received power of each beam transmitted by the network controlled repeater;
training the network controlled repeater compatible machine learning model based on the collected measurement data and the machine learning model; and
applying transfer learning in training the network controlled repeater compatible machine learning model based on the collected measurement data and parameters of the machine learning model trained for the beams transmitted by the network apparatus.

6. The terminal apparatus according to claim 3, wherein the instructions, when executed by the at least one processor, cause the terminal apparatus to perform:
collecting measurement data relating to the beams transmitted by the network controlled repeater, the measurement data comprising a measured reference signal received power of each beam transmitted by the network controlled repeater; and
training the network controlled repeater compatible machine learning model based on the collected measurement data and the machine learning model by initializing parameters randomly.

7. The terminal apparatus according to claim 3, wherein the instructions, when executed by the at least one processor, cause the terminal apparatus to perform:
collecting measurement data relating to the beams transmitted by the network controlled repeater, the measurement data comprising a measured reference signal received power of each beam transmitted by the network controlled repeater;
training the network controlled repeater compatible machine learning model based on the collected measurement data and the machine learning model; and
transmitting the network controlled repeater compatible machine learning model to the network apparatus (500).

8. The terminal apparatus according to claim 3, wherein the instructions, when executed by the at least one processor, cause the terminal apparatus to perform:
receiving the network controlled repeater compatible machine learning model from the network apparatus.

9. The terminal apparatus according to claim 1, wherein the instructions, when executed by the at least one processor, cause the terminal apparatus to perform:
transmitting to the network apparatus information relating to capabilities of the machine learning model for beam prediction.

10. The terminal apparatus according to claim 1, wherein the instructions, where the beams comprise synchronization signal block beams or channel state information reference signal beams.

11. A network apparatus comprising:
at least one processor; and
at least one memory storing instructions, that when executed by the at least one processor, cause the network apparatus to perform:
transmitting, to a terminal apparatus a message comprising an indication of downlink reference signal resources associated with beams allocated to a network controlled repeater.

12. The network apparatus according to claim 11, wherein the instructions, when executed by the at least one processor, cause the network apparatus to perform:
receiving, from the terminal apparatus, a network controlled repeater compatible machine learning model, the network controlled repeater compatible machine learning model being capable of predicting the best beam transmitted by the network controlled repeater.

13. The network apparatus according to claim 12, wherein the instructions, when executed by the at least one processor, cause the network apparatus to perform:
transmitting the network controlled repeater compatible machine learning model to a second terminal apparatus served by the network controlled repeater.

14. A method comprising:
receiving, by a terminal apparatus from a network apparatus, a message comprising an indication of downlink reference signal resources associated with beams allocated to a network controlled repeater, wherein the network controlled repeater appears transparent to the terminal apparatus; and
determining, by the terminal apparatus, the best beam among beams transmitted by the network apparatus and beams transmitted by the network controlled repeater based on a decision between the beams indicated in the message and beams predicted by a machine learning model.

15-17. (canceled)
